(19) United States
(12) Patent Application Publication
(10) Pub. No.: US 2025/0147161 A1
(43) Pub. Date: May 8, 2025

(54) OBJECT DETECTION APPARATUS

(71) Applicant: DENSO CORPORATION, Kariya-city (JP)

(72) Inventors: Sakiko UESAKA, Nisshin-city (JP); Yu KOYAMA, Nisshin-city (JP); Tetsuya AOYAMA, Kariya-city (JP); Takuya NOMURA, Kariya-city (JP)

(21) Appl. No.: 19/018,655

(22) Filed: Jan. 13, 2025

Related U.S. Application Data
(63) Continuation of application No. PCT/JP2023/025440, filed on Jul. 10, 2023.

(30) Foreign Application Priority Data
Jul. 15, 2022 (JP) 2022-114030

(51) Int. Cl. G01S 7/539; G01S 7/53; G01S 15/931

(52) U.S. Cl. CPC G01S 7/539; G01S 7/53; G01S 15/931; G01S 2015/938

(57) ABSTRACT

An object detection apparatus includes: a reception unit that acquires a reception signal corresponding to a reflected wave from the object of a transmission wave; and an information processing unit that acquires object information related to a shape of the object from a learning model by inputting a feature quantity and other measurement information of a waveform of the reception signal to the learned learning model in which machine learning to estimate the shape of an object has been performed. The learning model extracts, as temporal feature data, changes over time in a feature element in the reception signal based on the reception signal and a feature pattern of the object prescribed in advance, compresses the temporal feature data and acquires a plurality of feature quantities, and determines the shape of the object by calculating the plurality of feature quantities and the measurement information while weighting with a predetermined weight.

### CROSS-REFERENCE TO RELATED APPLICATION

The present application is a continuation application of International Application No. PCT/JP2023/025440, filed on Jul. 10, 2023, which claims priority to Japanese Patent Application No. 2022-114030 filed on Jul. 15, 2022. The contents of these applications are incorporated herein by reference in their entirety.

### BACKGROUND

The present disclosure relates to an object detection apparatus. An object detection apparatus that detects an object such as an obstacle based on a reception signal corresponding to a reflected wave from an object of a transmission wave that is an ultrasonic wave is known. In the apparatus, an object is detected by data in which the reception signal corresponding to the reflected wave is compressed being inputted into a neural network.

### SUMMARY

An aspect of the present disclosure provides an object detection apparatus that detects an object. The object detection apparatus includes a reception unit that acquires a reception signal corresponding to a reflected wave from the object of a transmission wave that is an ultrasonic wave, and an information processing unit that acquires object information related to a shape of the object from a learning model by inputting a feature quantity and other measurement information of a waveform of the reception signal to the learned learning model in which machine learning to estimate the shape of an object has been performed. The learning model extracts, as temporal feature data, changes over time in a feature element included in the reception signal based on the reception signal and a feature pattern of the object prescribed in advance, compresses the temporal feature data and acquires a plurality of feature quantities, and determines the shape of the object by calculating the plurality of feature quantities and the measurement information while weighting with a predetermined weight. The measurement information is information having a correlation with changes in the waveform of the reception signal or the shape of the object.

### BRIEF DESCRIPTION OF THE DRAWINGS

In the accompanying drawings:

FIG. 1 is a plan view of an overall configuration of a vehicle in which an onboard system configuring an object detection apparatus according to a first embodiment is mounted; FIG. 2 is an explanatory diagram for explaining an aspect of connection between each ultrasonic sensor and an electronic control apparatus;

FIG. 3 is a block diagram illustrating an overall functional configuration of the onboard system according to the first embodiment;

FIG. 4 is a block diagram illustrating a functional configuration of the ultrasonic sensor and the electronic control apparatus in the onboard system according to the first embodiment;

FIG. 5 is an explanatory diagram for explaining extraction of temporal feature data from a reception signal;

FIG. 6 is an explanatory diagram for explaining a relationship between an amplitude waveform of the reception signal, and a height and a measured distance of an object;

FIG. 7 is an explanatory diagram for explaining weighting based on a plurality of feature quantities and distance information when a distance to the object is close;

FIG. 8 is an explanatory diagram for explaining weighting based on a plurality of feature quantities and distance information when the distance to the object is far;

FIG. 9 is an explanatory diagram for explaining functions of the ultrasonic sensor and the electronic control apparatus in the onboard system according to the first embodiment;

FIG. 10 is a block diagram illustrating a functional configuration of an ultrasonic sensor and an electronic control apparatus in an onboard system according to a second embodiment;

FIG. 11 is an explanatory diagram for explaining functions of an ultrasonic sensor and an electronic control apparatus in an onboard system according to a third embodiment;

FIG. 12 is a block diagram illustrating an overall functional configuration of an onboard system according to a fourth embodiment;

FIG. 13 is an explanatory diagram for explaining functions of an ultrasonic sensor and an electronic control apparatus in the onboard system according to the fourth embodiment;

FIG. 14 is an explanatory diagram for explaining measurement information combined on the electronic control apparatus side;

FIG. 15 is an explanatory diagram for explaining a variation example of the measurement information combined on the electronic control apparatus side;

FIG. 16 is a block diagram illustrating an overall function configuration of an onboard system according to a fifth embodiment;

FIG. 17 is an explanatory diagram for explaining functions of an ultrasonic sensor and an electronic control apparatus in the onboard system according to the fifth embodiment; FIG. 18 is an explanatory diagram for explaining measurement information combined in a fully connected layer; and

FIG. 19 is an explanatory diagram for explaining a variation example of the measurement information combined in the fully connected layer.

### DESCRIPTION OF THE EMBODIMENTS

Conventionally, an object detection apparatus that detects an object such as an obstacle based on a reception signal corresponding to a reflected wave from an object of a transmission wave that is an ultrasonic wave is known (for example, refer to WO 2020/182963 A). In the apparatus described in WO 2020/182963 A, an object is detected by data in which the reception signal corresponding to the reflected wave is compressed being inputted into a neural network NNO.

The inventors of the present invention have examined acquiring object information related to a shape of an object by inputting a feature quantity included in a waveform of the reception signal corresponding to the reflected wave to a learned learning model in which machine learning to estimate the shape of an object has been performed. Specifically, the inventors have examined extracting changes over time in a feature element included in the reception signal as temporal feature data based on the reception signal and a feature pattern of the object prescribed in advance, and inputting compressed temporal feature data to the learning model as the feature quantity included in the reception signal.

However, based on research by the inventors of the present invention, it has been found that, because the reception signal corresponding to the reflected wave is affected by changes in a surrounding environment of the object including a positional relationship with the object and the like, highly accurate object information is difficult to acquire if only the feature quantity included in the reception signal is inputted to the learning model.

It is thus desired to provide an object detection apparatus that is capable of acquiring object information with high accuracy.

An exemplary embodiment of the present disclosure provides an object detection apparatus that detects an object. The object detection apparatus includes a reception unit that acquires a reception signal corresponding to a reflected wave from the object of a transmission wave that is an ultrasonic wave, and an information processing unit that acquires object information related to a shape of the object from a learning model by inputting a feature quantity and other measurement information of a waveform of the reception signal to the learned learning model in which machine learning to estimate the shape of an object has been performed. The learning model includes a feature extraction unit that extracts, as temporal feature data, changes over time in a feature element included in the reception signal based on the reception signal and a feature pattern of the object prescribed in advance, a data compression unit that compresses the temporal feature data and acquires a plurality of feature quantities, and a determination unit that determines the shape of the object by calculating the plurality of feature quantities and the measurement information while weighting with a predetermined weight. The measurement information is information having a correlation with changes in the waveform of the reception signal or the shape of the object.

In this way, if the configuration is such that not only the feature quantity included in the reception signal but also the measurement information having a correlation with the changes in the waveform of the reception signal is used, highly accurate object information can be acquired compared to a configuration in which only the feature amount included in the reception signal is inputted to the learning model.

Here, reference numbers in parentheses attached to constituent elements and the like indicate examples of corresponding relationships between the constituent elements and the like and specific constituent elements and the like described according to embodiments below.

Embodiments of the present disclosure will hereinafter be described with reference to the drawings. Here, according to the embodiments below, sections that are identical or equivalent to matters described according to preceding embodiments are given the same reference numbers. Descriptions thereof may be omitted. In addition, according to the embodiments, in cases in which a constituent element is only partially described, the constituent element described according to preceding embodiments can be applied to other parts the constituent element. According to the embodiments below, the embodiments can be partially combined with one another, even if such combinations are not explicitly described, as long as conflicts do not occur in the combinations.

### First Embodiment

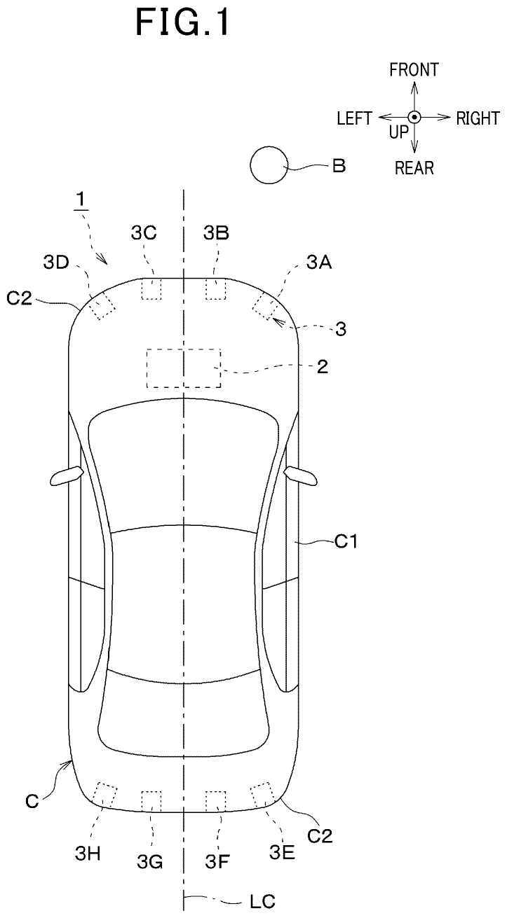

A present embodiment will be described with reference to FIG. 1 to FIG. 9.

According to the present embodiment, an example in which an object detection apparatus of the present disclosure is applied to an onboard system 1 will be described. As shown in FIG. 1, the onboard system 1 is mounted in a vehicle C serving as a mobile body. The vehicle C is a so-called four-wheeled automobile and includes a box-shaped vehicle body C1 that is formed into a substantially rectangular shape from a plan view. A shape of each section of the vehicle C from the “plan view” refers to a shape when the section is viewed from a line of sight in a same direction as a direction in which gravity acts in a state in which the vehicle C is stably placed on a horizontal plane so as to be capable of traveling. The vehicle C in which the onboard system 1 according to the present embodiment is mounted is referred to, hereafter, as an “own vehicle.”

Hereafter, from the plan view, a virtual line that passes through a center of the own vehicle in a vehicle width direction and is parallel to an overall vehicle length direction of the own vehicle is referred to as a vehicle center line LC. The overall vehicle length direction is a direction orthogonal to the vehicle width direction and orthogonal to a vehicle height direction. The vehicle height direction is a direction prescribing a vehicle height of the own vehicle and a direction parallel to the direction in which gravity acts when the own vehicle is stably placed on the horizontal plane so as to be capable of traveling. In addition, “front,” “rear,” “left,” “right,” and “up” are defined as indicated by arrows in FIG. 1. That is, the overall vehicle length direction is synonymous with a front/rear direction. Furthermore, the vehicle width direction is synonymous with a left/right direction.

The onboard system 1 includes an electronic control apparatus 2 and an ultrasonic sensor 3. The electronic control apparatus 2 is an onboard microcomputer that is also referred to as an ECU and includes a central processing unit (CPU), a read-only memory

(ROM), a random access memory (RAM), a non-volatile rewritable memory, and the like. The ECU is an abbreviation of Electronic Control Unit. The non-volatile rewritable memory is a memory that holds information in a rewritable manner while power is turned on and holds information in a non-rewritable manner while power is turned off. For example, the non- volatile rewritable memory may be a flash ROM. The ROM, the RAM, and the non-volatile rewritable memory are non-transitory, tangible storage media. The electronic control apparatus 2 is mounted inside the vehicle body C1.

The electronic control apparatus 2 is connected to the ultrasonic sensor 3 to be capable of transmitting and receiving information to and from the ultrasonic sensor 3 over an onboard information communication line. According to the present embodiment, a plurality of ultrasonic sensors 3 are mounted in the own vehicle. The electronic control apparatus 2 is configured to control an overall operation of the onboard system 1 including timings for transmission and reception operation for ultrasonic waves in each of the plurality of ultrasonic sensors 3, by reading and running a control program stored in the ROM or the non-volatile rewritable memory. That is, the onboard system 1 configuring the object detection apparatus according to the present embodiment is configured to detect an object B in the vicinity of the own vehicle based on transmission and reception results for ultrasonic waves in the ultrasonic sensors 3 in an onboard state of being mounted in the own vehicle.

A first front sensor 3A, a second front sensor 3B, a third front sensor 3C, and a fourth front sensor 3D that serve as the ultrasonic sensors 3 are mounted in a front bumper of the own vehicle, that is, a bumper C2 on a front surface side of the vehicle body C1. In a similar manner, a first rear sensor 3E, a second rear sensor 3F, a third rear sensor 3G, and a fourth rear sensor 3H that serve as the ultrasonic sensors 3 are mounted in a rear bumper of the own vehicle, that is, the bumper C2 on a rear surface side of the vehicle body C1.

The first front sensor 3A is provided in a right end portion of the front bumper so as to transmit a transmission wave ahead and to the right of the own vehicle. The second front sensor 3B is arranged between the first front sensor 3A and the vehicle center line LC in the vehicle width direction so as to transmit a transmission wave substantially ahead of the own vehicle. The third front sensor 3C is arranged in a position substantially symmetrical to the second front sensor 3B with the vehicle center line LC therebetween. The third front sensor 3C is arranged between the vehicle center line LC and the fourth front sensor 3D in the vehicle width direction so as to transmit a transmission wave substantially ahead of the own vehicle. The fourth front sensor 3D is arranged in a position substantially symmetrical to the first front sensor 3A with the vehicle center line LC therebetween. The fourth front sensor 3D is provided in a left end portion of the front bumper so as to transmit a transmission wave ahead and to the left of the own vehicle.

The first rear sensor 3E is provided in a right end portion of the rear bumper so as to transmit a transmission signal behind and to the right of the own vehicle. The second rear sensor 3F is arranged between the first rear sensor 3E and the vehicle center line LC in the vehicle width direction so as to transmit a transmission wave substantially behind the own vehicle. The third rear sensor 3G is arranged in a position substantially symmetrical to the second rear sensor 3F with the vehicle center line LC therebetween. The third rear sensor 3G is arranged between the vehicle center line LC and the fourth rear sensor 3H in the vehicle width direction so as to transmit a transmission wave substantially behind the own vehicle. The fourth rear sensor 3H is arranged in a position substantially symmetrical to the first rear sensor 3E with the vehicle center line LC therebetween. The fourth rear sensor 3H is provided in a left end portion of the rear bumper to transmit a transmission signal behind and to the left of the own vehicle.

Here, wire harnesses in the vehicle C have been reduced in recent years from the perspective of carbon neutrality and cost reduction. Taking this into consideration, as shown in FIG. 2, in the onboard system 1 according to the present embodiment, the plurality of ultrasonic sensors 3 and the electronic control apparatus 2 are connected to each other by a bus-type network.

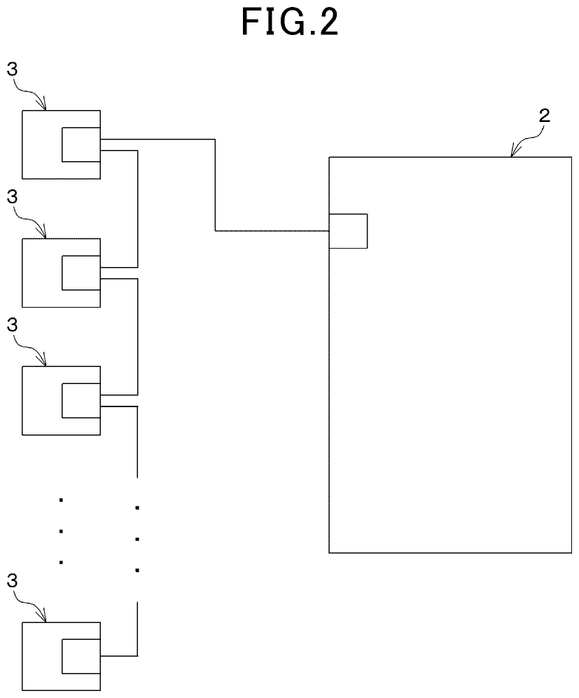

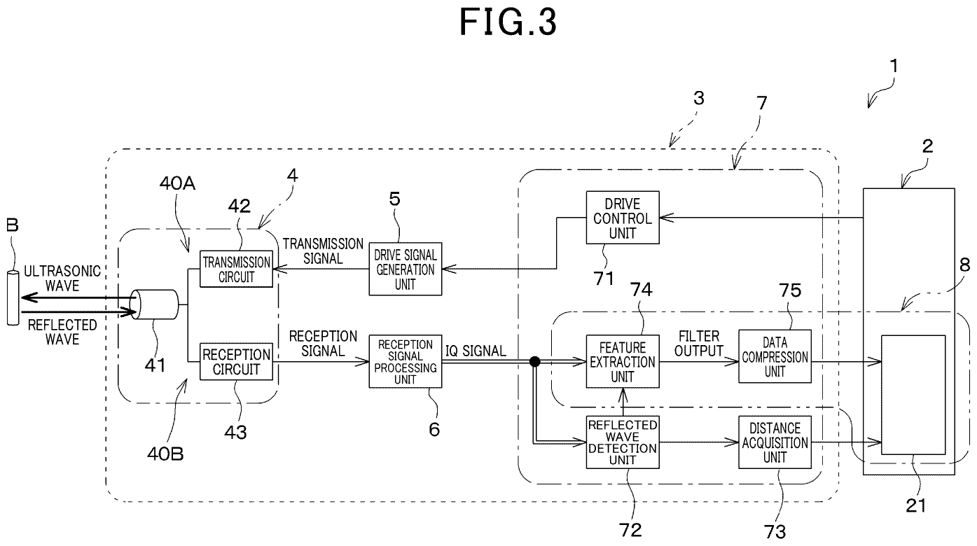

Next, an overall configuration of the ultrasonic sensor 3 will be described with reference to FIG. 3. Here, in FIG. 3, to simplify the drawing, only one of the plurality of ultrasonic sensors 3 connected to the electronic control apparatus 2 is shown. The other ultrasonic sensors 3 are omitted from the drawing.

The ultrasonic sensor 3 is configured to transmit a transmission wave that is an ultrasonic wave toward outside the own vehicle. In addition, the ultrasonic sensor 3 is configured to detect an object B that is present in the vicinity and acquire a distance to the object B based on a reception signal that corresponds to a reception wave including a reflected wave of the transmission wave from the object B.

Specifically, the ultrasonic sensor 3 includes a transmission/reception unit 4, a drive signal generation unit 5, a reception signal processing unit 6, and a sensor control unit 7. According to the present embodiment, the transmission/reception unit 4, the drive signal generation unit 5, the reception signal processing unit 6, and the sensor control unit 7 are supported by a single sensor housing that is formed from synthetic resin or the like.

According to the present embodiment, the ultrasonic sensor 3 includes only a single transmission/reception unit 4 and is configured to provide transmission and reception functions through the transmission/reception unit 4. That is, the transmission/reception unit 4 provides a function as a transmission unit 40A that transmits the transmission wave towards the outside and a function as a reception unit 40B that receives the reception wave. Specifically, the single transmission/reception unit 4 has a single transducer 41. The transmission unit 40A and the reception unit 40B are configured to respectively actualize the transmission function and the reception function using the shared transducer 41.

The transducer 41 is configured to provide a function as a transmitter that transmits the transmission wave towards the outside and a receiver that receives the reflected wave. The transducer 41 has a configuration as a so-called resonant-type ultrasonic microphone including an electrical-mechanical energy conversion element such as a piezoelectric element therein.

The transmission/reception unit 4 includes the transducer 41, a transmission circuit 42, and a reception circuit 43. That is, the transmission unit 40A includes the transducer 41 and the transmission circuit 42. In addition, the reception unit 40B includes the transducer 41 and the reception circuit 43. The transducer 41 is electrically connected to the transmission circuit 42 and the reception circuit 43.

The transmission circuit 42 is provided to cause the transducer 41 to transmit a transmission wave in an ultrasonic band by driving the transducer 41 based on an inputted drive signal. Specifically, the transmission circuit 42 has a digital/analog conversion circuit and the like. That is, the transmission circuit 42 is configured to perform a process such as digital/analog conversion on the drive signal outputted from the drive signal generation unit 5 and apply an alternating current voltage generated as a result to the transducer 41.

The reception circuit 43 is provided to generate the reception signal corresponding to a reception result of the ultrasonic wave in the transducer 41 and output the generated reception signal to the reception signal processing unit 6. Specifically, the reception circuit 43 has an amplifier circuit, an analog/digital conversion circuit, and the like. That is, the reception circuit 43 is configured to generate and output the reception signal based on a frequency, a phase, and an amplitude of the received ultrasonic wave by performing signal processing such as amplification and analog/digital conversion on a voltage signal inputted from the transducer 41.

The drive signal generation unit 5 is provided to generate a drive signal that drives the transmission unit 40A. The drive signal is a signal for driving the transmission unit 40A and making the transducer 41 transmit the transmission wave.

The reception signal processing unit 6 is provided to perform various types of signal processing such as a filter process and a quadrature detection process on the reception signal outputted from the reception circuit 43. In addition, the reception signal processing unit 6 is provided to output a processed signal that is a result of the various types of signal processing to the sensor control unit 7.

The sensor control unit 7 is connected to the electronic control apparatus 2 so as to be capable of information communication to control operation of the ultrasonic sensor 3 while cooperating with the electronic control apparatus 2. That is, the sensor control unit 7 is configured to control output of the drive signal from the drive signal generation unit 5 to the transmission unit 40A, and detect the object B based on the processed signal outputted from the reception signal processing unit 6.

The sensor control unit 7 has a configuration as an onboard microcomputer including a CPU, a ROM, a RAM, a non-volatile rewritable memory, and the like (not shown). That is, the sensor control unit 7 is configured to control operations of the ultrasonic sensor 3 by reading and running a control program stored in the ROM or the non-volatile rewritable memory. Specifically, the sensor control unit 7 includes, as functional configurations actualized in the ultrasonic sensor 3, a drive control unit 71, a reflected wave detection unit 72, and a distance acquisition unit 73.

The drive control unit 71 controls a transmission state of the transmission wave from the transmission unit 40A by outputting a control signal to the drive signal generation unit 5.

The control signal is a signal for controlling output characteristics, specifically, an output timing, a frequency, and the like of the drive signal outputted from the drive signal generation unit 5 to the transmission/reception unit 4. That is, the drive control unit 71 controls the output timing, the frequency, and the like of the drive signal generated and outputted by the drive signal generation unit 5.

The reflected wave detection unit 72 detects the reception wave including the reflected wave of the transmission wave from the object B included in the reception signal. The reflected wave detection unit 72 determines whether a feature portion exceeding a predetermined amplitude value is present in an amplitude waveform of the reception signal acquired through a predetermined filter, and detects the reflected wave based on the determination result.

The distance acquisition unit 73 acquires a measured distance that is a distance to the object B based on the reception signal. Specifically, according to the present embodiment, for example, the distance acquisition unit 73 may calculate the measured distance based on a reception time of a peak in an amplitude signal included in the reception signal when the reflected wave detection unit 72 detects the reflected wave.

According to the present embodiment, the onboard system 1 including the electronic control apparatus 2 and the ultrasonic sensor 3 is configured to detect a height of the object B as a shape of the object B based on the reception signal of the ultrasonic sensor 3. The onboard system 1 according to the present embodiment includes an information processing unit 8 that acquires object information related to the shape of the object B from a learning model by inputting a feature quantity and other pieces of measurement information of the waveform of the reception signal to the learned learning model in which machine learning to estimate the shape of the object B has been performed. The learning model of the information processing unit 8 is configured by a neural network.

The information processing unit 8 is configured to include not only the electronic control apparatus 2 but also a portion of the sensor control unit 7 included in the ultrasonic sensor 3. The learning model of the information processing unit 8 is a learned model that has been learned using a plurality of pieces of teaching data pairing the feature quantity and other measurement information of the waveform of the reception signal serving as input with the shape of the object B. In the learning model, a portion in which the feature quantity and other measurement information of the waveform of the reception signal are inputted in the ultrasonic sensor 3 configures an input layer and a portion that outputs the object information in the electronic control apparatus 2 configures an output layer. The learning model includes a feature extraction unit 74 and a data compression unit 75 of the sensor control unit 7, and a determination unit 21 of the electronic control apparatus 2 as an intermediate layer. At least a portion of the intermediate layer is configured to perform a calculation process on an input value using a predetermined weight and subsequently output a calculated value determined in the calculation process through an activation function. Here, the activation function is a function for performing a nonlinear transformation process.

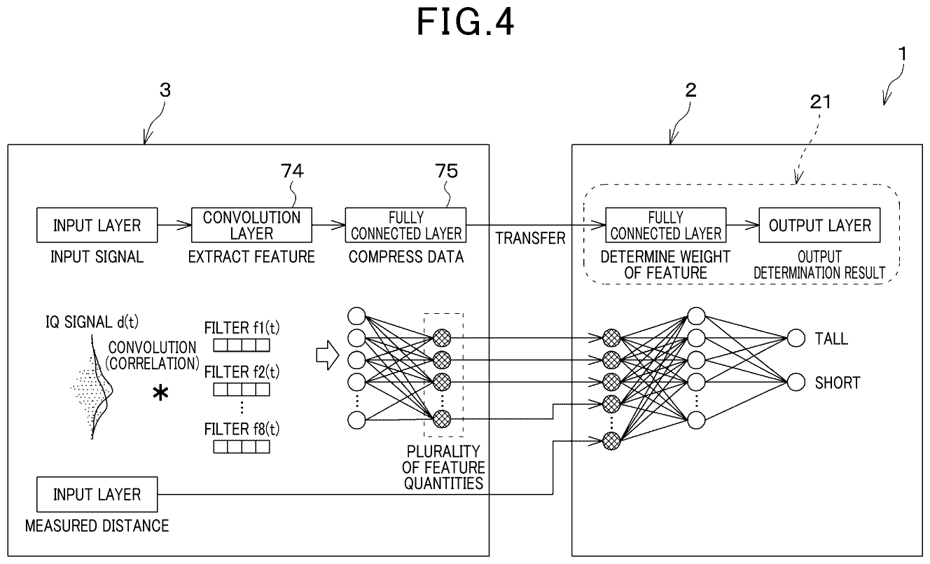

The feature extraction unit 74 extracts changes over time in a feature element included in the reception signal as temporal feature data, based on the reception signal and a feature pattern of the object B prescribed in advance. The feature extraction unit 74 functions as a convolution layer in a neural network. The feature extraction unit 74 configures a portion of the learning model. As shown in FIG. 4, the feature extraction unit 74 extracts the changes over time in a feature element included in an IQ signal that is the reception signal as the temporal feature data, by convolution operations using a plurality of learned filters corresponding to the feature pattern of the object B. The IQ signal is a signal including two components, an in-phase I and a quadrature phase Q. If the configuration is such that the temporal feature data is extracted from the IQ signal in this manner, the temporal feature data includes not only amplitude changes but also phase changes. Therefore, compared to a case in which the temporal feature data is merely extracted from the amplitude waveform of the reception signal, appropriate data extraction can be performed.

Here, FIG. 5 is an explanatory diagram for explaining extraction of the temporal feature data from the reception signal. To facilitate understanding, FIG. 5 shows an example in which the temporal feature data is extracted from an amplitude component of the IQ signal.

However, in actuality, the temporal feature data is extracted from the IQ signal.

As shown in FIG. 5, the feature extraction unit 74 identifies the feature element present in a portion of the amplitude waveform of the reception signal exceeding a predetermined threshold. Then, with a predetermined period including the feature element as a reflected wave region, the feature extraction unit 74 extracts the changes over time in the feature element in the reflected wave region as the temporal feature data. The reflected wave region may be set for a period longer than the period in which the predetermined threshold is exceeded, or may be set for a same period as the period in which the predetermined threshold is exceeded in the amplitude waveform of the reception signal. As a result of the data being extracted from the reflected wave region including the feature element in this manner, processing load on the feature extraction unit 74 can be suppressed. Here, identification of the feature element by the feature extraction unit 74 can be achieved, for example, through use of a correlation filter that has a correlation with the reflected wave. Here, rather than extracting the temporal feature data from the IQ signal, the feature extraction unit 74 may extract the temporal feature data from the amplitude component of the IQ signal.

The data compression unit 75 compresses the temporal feature data extracted by the feature extraction unit 74 and acquires a plurality of feature quantities. The data compression unit 75 functions as a fully connected layer in the neural network. The data compression unit 75 compresses the data by a number of nodes in the fully connected layer configuring the data compression unit 75 being less than the number of nodes in the convolution layer configuring the feature extraction unit 74. The data compressed by the data compression unit 75 is transferred to the electronic control apparatus 2 over the bus-type network shown in FIG. 2.

Here, while the bus-type network is advantageous in that wire harnesses between the ultrasonic sensor 3 and the electronic control apparatus 2 can be reduced, there is a drawback in that a communication amount tends to become excessive as a result of concentration of communication load.

In this regard, the onboard system 1 according to the present embodiment is configured to transfer the data compressed on the ultrasonic sensor 3 side to the electronic control apparatus 2. Consequently, reduction in wire harnesses between the ultrasonic sensor 3 and the electronic control apparatus 2, and transfer of data suppressing increase in the communication amount can both be achieved.

The determination unit 21 determines the shape of the object B by calculating the measurement information and the plurality of feature quantities obtained by compression by the data compression unit 75 while weighting with a predetermined weight. Specifically, the determination unit 21 according to the present embodiment determines whether the object B is a tall object or a short object. The determination unit 21 functions as the fully connected layer in the neural network. The determination unit 21 may be configured as a single fully connected layer or a plurality of fully connected layers. In the determination unit 21, the number of nodes in the fully connected layer is preferably greater than the number of nodes in the fully connected layer configuring the data compression unit 75 to improve determination accuracy. The weight used in the determination unit 21 is set when the learning model is obtained using the teaching data.

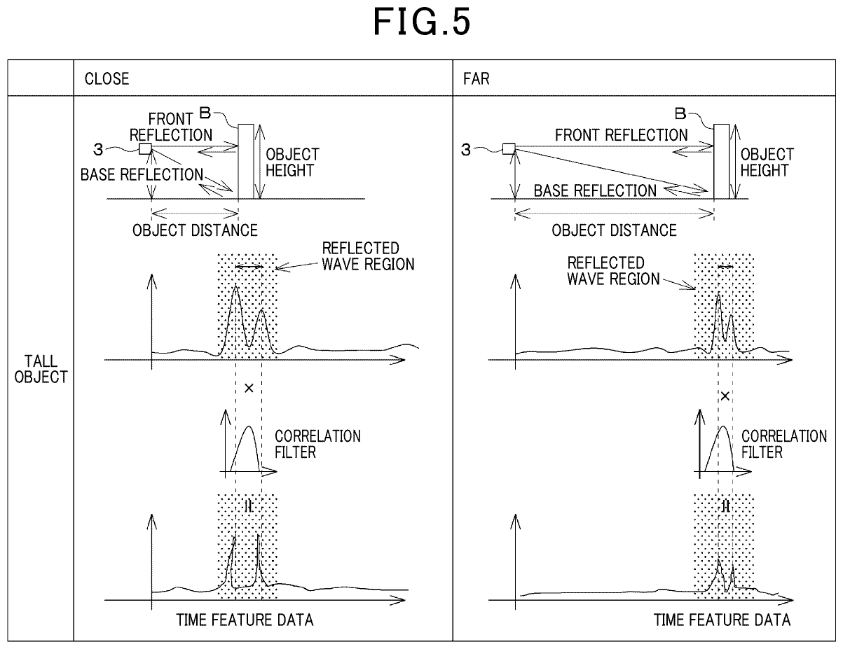

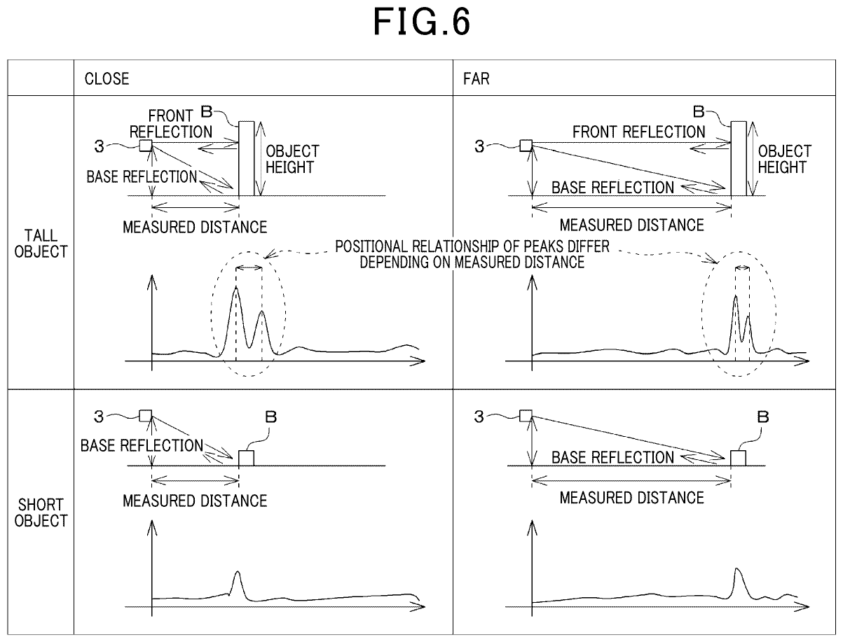

Here, in the reception signal received by the ultrasonic sensor 3, a manner in which a feature appears changes nonlinearly based on the shape of the object B, a surrounding environment, and the like. A relationship between the amplitude waveform of the reception signal, and the height and the measured distance of the object B will hereinafter be described with reference to FIG. 6.

For example, in a case in which the object B is a tall portion such as a wall or a pole, as shown in an upper section in FIG. 6, two peaks appear in the amplitude waveform of the reception signal, a peak corresponding to a front reflection and a peak corresponding to a base reflection. In a case in which the object B is a short object such as a curbstone, as shown in a lower section in FIG. 6, a single peak corresponding to the base reflection appears in the amplitude waveform of the reception signal. In this way, a certain correlation is present between the amplitude waveform of the reception signal and the shape of the object B.

In addition, although the reflected wave from the object B theoretically has the same waveform as the transmission wave, a shift in phase in relation to the transmission wave may occur due to a positional relationship between the ultrasonic sensor 3 and the object B. The shift in phase such as this affects the amplitude waveform of the reception signal. That is, changes in the phase of the reflected wave are correlated with changes in the waveform of the reception signal.

Furthermore, as shown on a left side in FIG. 6, when the measured distance is a close distance, the two peaks of the tall object are clearly separated. In contrast, as shown on a right side in FIG. 6, when the measured distance is a long distance, the two peaks of the tall object are closer. The two peaks of the tall object may be combined to substantially form a single peak. In this manner, a certain correlation is present between the measured distance of the object B and the changes in the waveform of the reception signal. In particular, when the object B is a tall object, effects of the differences in the distance to the object B on the waveform of the reception signal corresponding to the reflected wave tend to be more pronounced. Here, a magnitude of the amplitude waveform of the reception signal is not only attenuated depending on the distance to the object B, but also varies based on changes in an angle of the base reflection depending on the changes in the distance to the object B. Therefore, a certain correlation is also present between the magnitude of the amplitude waveform of the reception signal and the shape (such as the height) of the object B.

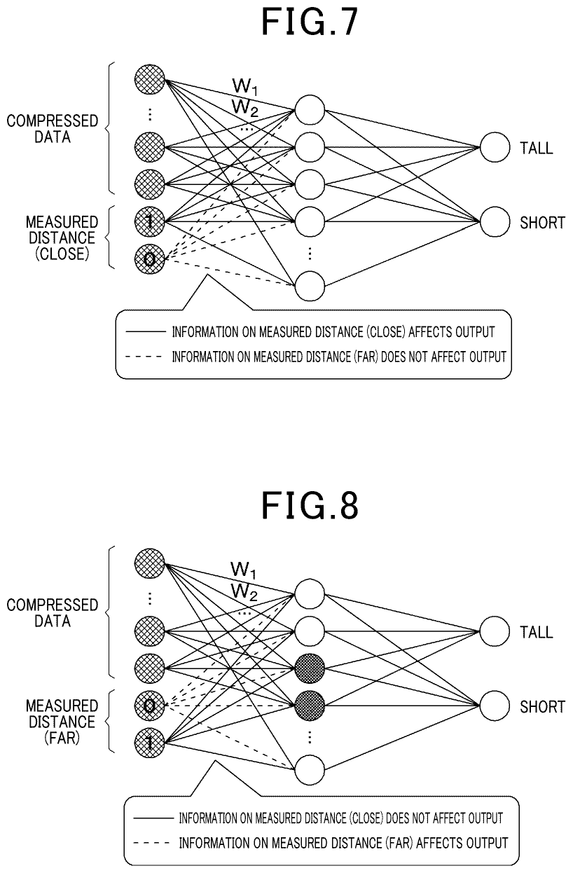

Taking the foregoing into consideration, the determination unit 21 according to the present embodiment is configured to determine the shape of the object B by calculating the measured distance of the object B as the measurement information, together with the plurality of feature quantities obtained by compression by the data compression unit 75, while weighting with a predetermined weight. As shown in FIG. 7 and FIG. 8, for example, the determination unit 21 then outputs the information indicating that the height of the object B is “tall” or “short” as the determination result for the shape of the object B.

Here, the measured distance expressed as a one-hot vector is inputted to the determination unit 21. In the examples shown in FIG. 7 and FIG. 8, a state in which the object B is close and the measured distance is small is (1, 0) and a state in which the object B is far and the measured distance is great is (0, 1). Here, the measured distances shown in FIG. 7 and FIG. 8 are merely examples and may differ therefrom. For example, a state in which the measured distance is small may be expressed as (1, 0, 0), a state in which the measured distance is great may be expressed as (0, 1, 0), and a state in which the measured distance is intermediate may be expressed as (0, 0, 1).

In the determination unit 21 configured in this manner, when the measured distance is close, as shown in FIG. 7, information of a node indicating close distance affects output and information of a node indicating far distance does not affect output. When the measured distance is far, as shown in FIG. 8, the information of the node indicating close distance does not affect output and the information of the node indicating far distance affects output. As a result of such a configuration, the determination unit 21 can appropriately determine whether the object B is a “tall object” that is tall in height or a “short object” that is short in height.

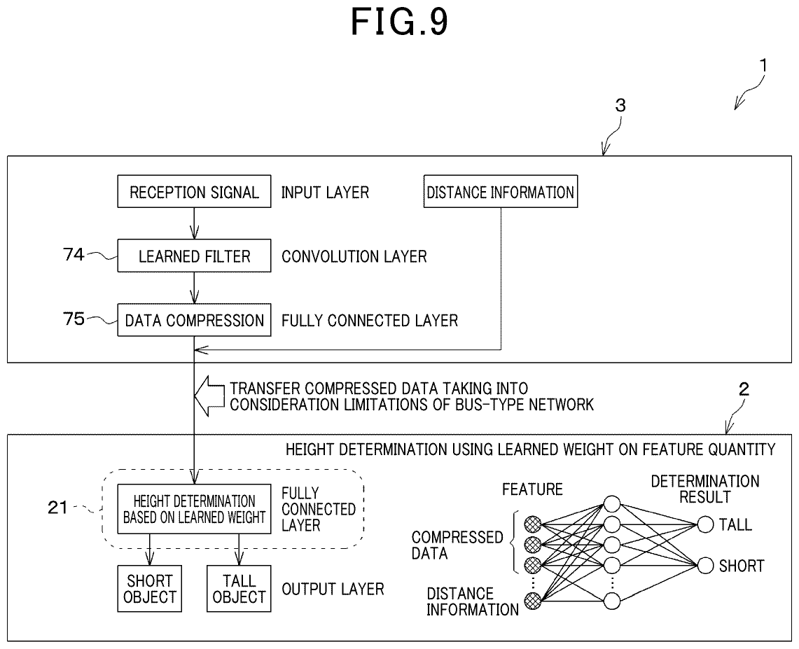

Next, an object detection process by the onboard system 1 will be described with reference to FIG. 9. The electronic control apparatus 2 makes each of the plurality of ultrasonic sensors 3 repeatedly perform an object detection operation at a predetermined cycle when a predetermined object detection condition is met. Upon receiving a command signal from the electronic control apparatus 2, the ultrasonic sensor 3 repeatedly performs a detection process for the object B at a predetermined cycle.

When the detection process for the object B is started, the plurality of ultrasonic sensors 3 emit transmission waves that are ultrasonic waves in a predetermined sequence. In addition, the ultrasonic sensors 3 periodically receive the reception waves that include the reflected waves from the object B of the transmission waves.

Next, the ultrasonic sensor 3 calculates the measured distance based on a reception time of the peak in the amplitude signal included in the reception signal when the reflected wave is detected and the like. In addition, the ultrasonic sensor 3 extracts changes over time in the feature element included in the reception signal as the temporal feature data, based on the reception signal corresponding to the reception wave and the feature pattern of the object

B prescribed in advance. As shown in FIG. 9, the ultrasonic sensor 3 according to the present embodiment extracts the temporal feature data using a learned filter in the convolution layer of a learning model. In the convolution layer of the learning model, feature extraction in which information indicating the position of the peak in the waveform of the reception signal remains can be performed. Therefore, when two peaks appear in the amplitude waveform of the reception signal, a feature element that is the distance information between the two peaks can be extracted.

Then, the ultrasonic sensor 3 compresses the temporal feature data and acquires a plurality of feature quantities in the fully connected layer of the learning model, and subsequently transfers the data including the plurality of feature quantities and the measured distance to the electronic control apparatus 2 over the bus-type network.

Upon receiving the data including the plurality of feature quantities and the measured distance from the ultrasonic sensors 3, the electronic control apparatus 2 determines the shape of the object B by calculating the plurality of feature quantities and the measured distance while weighting with learned weight in the fully connected layer of the learning model. The electronic control apparatus 2 then outputs the information indicating that the height of the object B is “tall” or “short” as the determination result for the shape of object B. Here, the electronic control apparatus 2 may output information other than the information indicating that the height of the object B is “tall” or “short” as the determination result for the shape of the object B.

The onboard system 1 described above is configured to determine the shape of the object B using not only the feature quantity included in the reception signal corresponding to the reflected wave from the object B, but also the measurement information having a correlation with the changes in the waveform of the reception signal. As a result, compared to a configuration in which only the feature quantity included in the reception signal is inputted to the learning model, highly accurate object information can be acquired.

In addition, the onboard system 1 according to the present embodiment includes the following features.

(1) The ultrasonic sensor 3 includes the distance acquisition unit 73 that acquires the measured distance that is the distance to the object B based on the reception signal. The electronic control apparatus 2 determines the shape of the object B using not only the feature quantity included in the reception signal corresponding to the reflected wave from the object B, but also the measured distance. As a result of examination by the inventors of the present invention, it has been found that the waveform of the reception signal corresponding to the reflected wave changes depending on the distance to the object B. In particular, when the object B is a tall object, the effects of the differences in the distance to the object B on the waveform of the reception signal corresponding to the reflected wave tend to be more pronounced. In this way, it can be said that a certain correlation is present between the distance to the object B and the changes in the waveform of the reception signal. Therefore, if the configuration is such that the shape of the object B is determined by the plurality of feature quantities and the distance to the object B being calculated while weighting with a predetermined weight, with the distance to the object B as the measurement information, the shape of the object B can be appropriately determined.

In particular, the onboard system 1 according to the present embodiment performs “feature extraction by convolution” and “data compression” on the ultrasonic sensor 3 side, and inputs the distance information to the learning model in the one-hot vector format on the electronic control apparatus 2 side. Consequently, the height of the object B can be determined with high accuracy.

(2) The feature extraction unit 74 identifies the feature element present in the portion of the amplitude waveform of the reception signal exceeding the predetermined threshold, and extracts the changes over time in the feature element during the predetermined period including the feature element as the temporal feature data. Consequently, an amount of data processed by the information processing unit 8 can be efficiently reduced.

(3) The data compression unit 75 and the determination unit 21 configuring the information processing unit 8 are provided in differing components. Specifically, in the information processing unit 8, the data compression unit 75 is provided in the ultrasonic sensor 3 and the determination unit 21 is provided in the electronic control apparatus 2. In addition, the plurality of feature quantities compressed by the data compression unit 75 are transferred to the determination unit 21 over the communication network. In this way, if the configuration is such that the compressed plurality of feature quantities are transferred from the data compression unit 75 to the determination unit 21 over the communication network, compared to a case in which unprocessed RAW data is transferred, an amount of data communication within the communication network can be suppressed.

(4) The measured distance expressed as the one-hot vector is inputted in the determination unit 21 as the measurement information. In this way, if the configuration is such that the measurement information expressed as the one-hot vector is used, variables other than numeric values, that is, far and close can be used as the measurement information and the variables inputted to the determination unit 21 can be processed equally. This contributes to an appropriate determination of the shape of the object B by the learning model.

In addition, the measurement information expressed as the one-hot vector does not require normalization or standardization. This contributes to improvement in processing speed, load reduction, and the like in the information processing unit 8.

### Second Embodiment

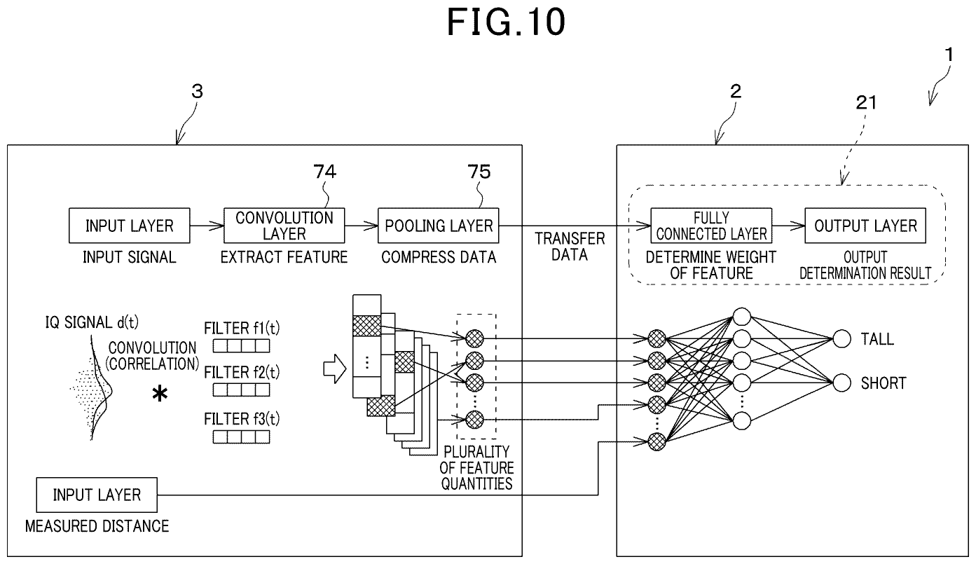

Next, a second embodiment will be described with reference to FIG. 10. According to the present embodiment, sections differing from those according to the first embodiment will mainly be described.

The learning model of the information processing unit 8 according to the present embodiment is configured by a convolutional neural network (a so-called CNN). As shown in FIG. 10, the data compression unit 75 functions not as the fully connected layer but as a pooling layer that reduces data by capturing only a representative feature quantity from the temporal feature data extracted by the feature extraction unit 74. Unlike the fully connected layer, the pooling layer has no parameters such as weight and can therefore suppress excessive use of memory in the ultrasonic sensor 3.

The data compression unit 75 according to the present embodiment compresses the temporal feature data by extracting a maximum value from a plurality of patches in the temporal feature data extracted by the feature extraction unit 74 by, for example, a max pooling method. Here, the data compression unit 75 may compress the temporal feature data using an average pooling method.

Other sections are similar to those according to the first embodiment. The onboard system 1 according to the present embodiment can achieve effects achieved by configurations shared with or equivalent to the first embodiment in a manner similar to that according to the first embodiment.

In addition, the onboard system 1 according to the present embodiment includes the following features.

(1) The data compression unit 75 according to the present embodiment functions as the pooling layer. Consequently, the temporal feature data extracted by the feature extraction unit 74 can be compressed and transferred to the electronic control apparatus 2 while suppressing excessive use of the memory in the ultrasonic sensor 3.

### Third Embodiment

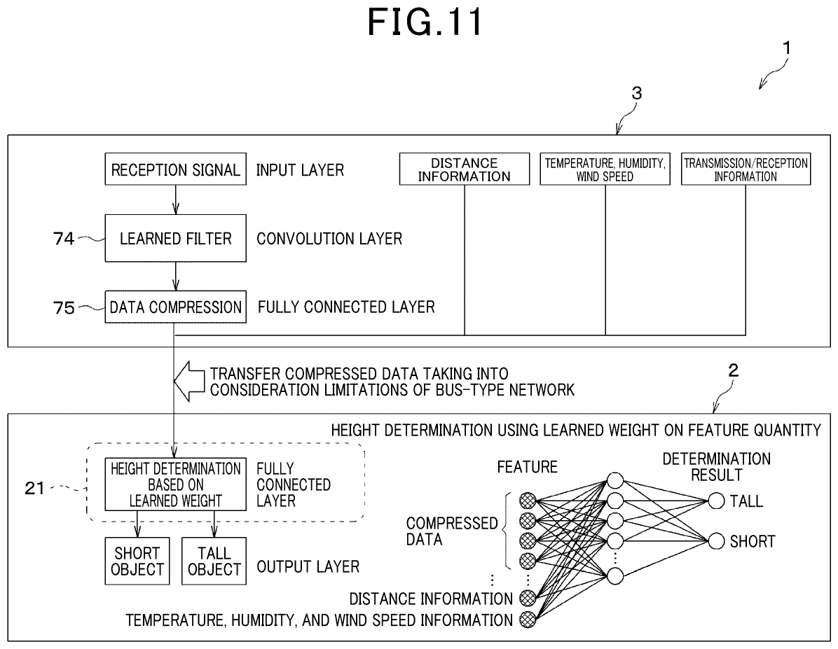

Next, a third embodiment will be described with reference to FIG. 11. According to the present embodiment, sections differing from those according to the first embodiment will mainly be described.

The waveform of the reception signal corresponding to the reflected wave varies nonlinearly depending on variations in sound velocity based on temperature, humidity, and wind speed in the vicinity of the ultrasonic sensor 3 in which the receiver 40B is mounted. Therefore, the temperature, humidity, and wind speed in the vicinity of the ultrasonic sensor 3 have a certain correlation with the changes in the waveform of the reception signal.

In addition, regarding the waveform of the reception signal corresponding to the reflected wave, the waveform of the reception signal corresponding to the reflected wave changes depending on a positional relationship between a position from which the transmission wave is emitted and a position at which the reception signal is received. For example, the waveform of the reception signal corresponding to the reflected wave from the object B of the transmission wave emitted by the first front sensor 3A may differ between the first front sensor 3A and the second front sensor 3B. In this way, transmission/reception information for identifying the positional relationship between the position from which the transmission wave is emitted and the position at which the reception signal is received has a certain correlation with the waveform of the reception signal corresponding to the reflected wave.

In light of the foregoing, as shown in FIG. 11, the onboard system 1 according to the present embodiment determines the shape of the object B using not only the feature quantity included in the reception signal corresponding to the reflected wave from the object B, but also the measured distance, the temperature, humidity, and wind speed in the vicinity of the ultrasonic sensor 3, and the transmission/reception information.

The ultrasonic sensor 3 according to the present embodiment is configured to be capable of measuring the temperature, humidity, and wind speed in the vicinity of the ultrasonic sensor 3. The ultrasonic sensor 3 according to the present embodiment is configured to be capable of outputting data associating a mounting position of the ultrasonic sensor 3 itself in the vehicle C and transmission/reception of the signals as the sensor information.

When the detection process for the object B is started, upon receiving the command signal from the electronic control apparatus 2, the plurality of ultrasonic sensors 3 emit transmission waves that are ultrasonic waves in a predetermined sequence. In addition, the ultrasonic sensors 3 periodically receive the reception waves that include the reflected waves from the object B of the transmission waves.

Next, the ultrasonic sensor 3 calculates the measured distance and extracts the temporal feature data. The ultrasonic sensor 3 also measures the temperature, humidity, and wind speed in the vicinity of the ultrasonic sensor 3. In addition, the ultrasonic sensor 3 compresses the temporal feature data and acquires a plurality of feature quantities in the fully connected layer of the learning model. Subsequently, the ultrasonic sensor 3 transfers the data including the plurality of feature quantities, the measured distance, the temperature, humidity, and windspeed, and the transmission/reception information to the electronic control apparatus 2 over the bus-type network.

Upon receiving the data including the plurality of feature quantities, the measured distance, the temperature, humidity, and windspeed, and the transmission/reception information from the ultrasonic sensor 3, the electronic control apparatus 2 determines the shape of the object B by calculating the plurality of feature quantities, the measured distance, the temperature, humidity, and windspeed, and the transmission/reception information while weighting with learned weight in the fully connected layer of the learning model. Then, the electronic control apparatus 2 outputs the information indicating that the height of the object B is “tall” or “short” as the determination result for the shape of object B. Here, the measurement information expressed as the one-hot vector is inputted to the determination unit 21 of the electronic control apparatus 2.

Other sections are similar to those according to the first embodiment. The onboard system 1 according to the present embodiment can acquire effects achieved by configurations shared with or equivalent to the first embodiment in a manner similar to that according to the first embodiment.

In addition, the onboard system 1 according to the present embodiment includes the following features.

(1) The electronic control apparatus 2 determines the shape of the object B using not only the feature quantity included in the reception signal corresponding to the reflected wave from the object B, but also the temperature, humidity, and wind speed in the vicinity of the ultrasonic sensor 3. The temperature, humidity, and wind speed have a certain correlation with the changes in the waveform of the reception signal. Therefore, if the configuration is such that the shape of the object B is determined by the plurality of feature quantities and the temperature, humidity, and wind speed in the vicinity of the above-described apparatus being calculated while weighting with a predetermined weight, with the temperature, humidity, and wind speed as the measurement information, the shape of the object B can be appropriately determined.

(2) The electronic control apparatus 2 determines the shape of the object B using not only the feature quantity included in the reception signal corresponding to the reflected wave from the object B, but also the transmission/reception information for identifying the position at which the reception signal is received in relation to the position from which the transmission wave is emitted. The waveform of the reception signal corresponding to the reflected wave changes depending on the position at which the reception signal is received in relation to the position from which the transmission wave is emitted. Therefore, if the configuration is such that the shape of the object B is determined by the plurality of feature quantities and the transmission/reception information being calculated while weighting with a predetermined weight, with the transmission/reception information as the measurement information, the shape of the object B can be appropriately determined.

### Variation Examples According to the Third Embodiment

The electronic control apparatus 2 may be configured to determine the shape of the object B by calculating the plurality of feature quantities and one or two of the temperature, humidity, and windspeed in the vicinity of the ultrasonic sensor 3 while weighting with a predetermined weight, with one or two of the temperature, humidity, and windspeed as the measurement information. The electronic control apparatus 2 acquires the measurement information that is the temperature, humidity, and windspeed from the ultrasonic sensor 3, but may acquire the measurement information from an apparatus other than the ultrasonic sensor 3.

The electronic control apparatus 2 is preferably configured to determine the shape of the object B by calculating the plurality of feature quantities and the transmission/reception information while weighting with a predetermined weight, with the transmission/reception information as the measurement information, but may not be configured as such.

### Fourth Embodiment

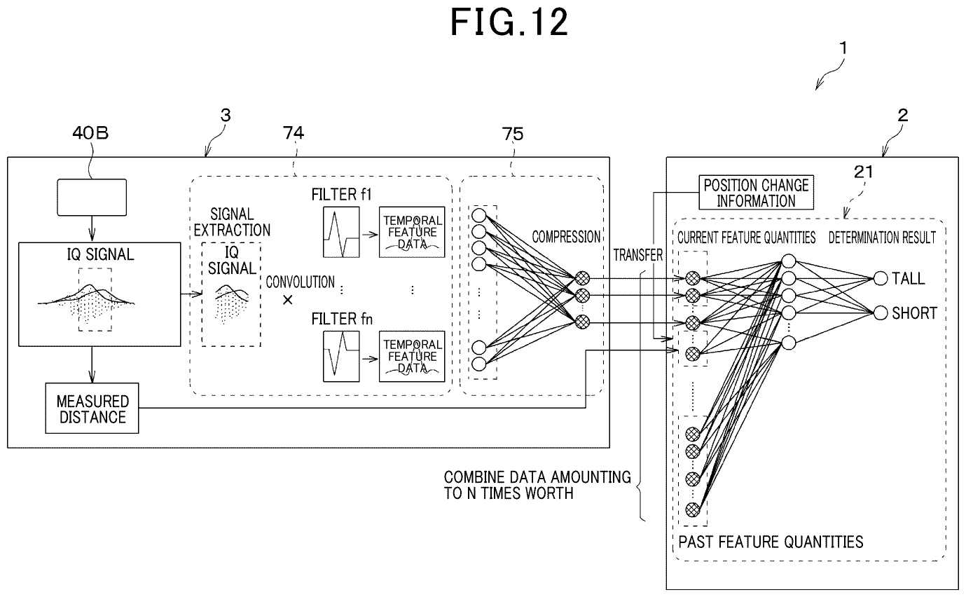

Next, a fourth embodiment will be described with reference to FIG. 12 to FIG. 14. According to the present embodiment, sections differing from those according to the first embodiment will mainly be described.

The plurality of feature quantities obtained by compressing the temporal feature data extracted by the feature extraction unit 74 are based on the feature element having a correlation with the shape of the object B and is information having a certain correlation with the shape of the object B. This similarly applies not only to the plurality of feature quantities obtained by compressing the temporal feature data currently extracted by the feature extraction unit 74 (also referred to, hereafter, as a current feature quantity) but also to the plurality of feature quantities obtained by compressing the temporal feature data extracted by the feature extraction unit 74 in the past (also referred to, hereafter, as a past feature quantity). Therefore, the past feature quantity is information having a certain correlation with the shape of the object B.

In addition, because the waveform of the reception signal corresponding to the reflected wave changes based on the position at which the reception signal is received, position change information indicating changes in the position can be said to have a certain correlation with the changes in the shape of the reception signal.

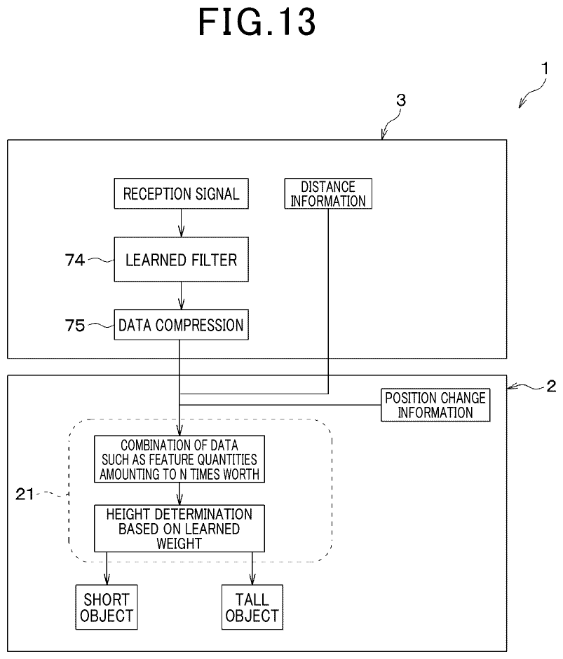

Taking the foregoing into consideration, as shown in FIG. 12 and FIG. 13, the onboard system 1 according to the present embodiment determines the shape of the object B using not only the current feature quantity included in the reception signal corresponding to the reflected wave from the object B but also the past feature quantity and the position change information.

Upon receiving the plurality of feature quantities obtained by compressing the temporal feature data extracted by the feature extraction unit 74, the electronic control apparatus 2 stores the plurality of feature quantities in the memory. As a result, the electronic control apparatus 2 accumulates the feature quantities amounting to N times worth, including the current feature quantity and the past feature quantity. The electronic control apparatus 2 also acquires wheel speed pulses from a wheel speed sensor as the position change information. Then, the determination unit 21 of the electronic control apparatus 2 weights the feature quantities combining the current feature quantity and the past feature quantity to amount to N times worth, the measured distance, and the position change information acquired from the ultrasonic sensor 3, with the learned weight in the fully connected layer of the learning model, and combines the data such as the feature quantities amounting to N times worth. The determination unit 21 determines the shape of the object B based on the data such as the feature quantities amounting to N times worth. Here, the measurement information expressed as the one-hot vector is input to the determination unit 21 of the electronic control apparatus 2. In addition, regarding the past feature quantity inputted to the learning model, how far back is included is determined as appropriate based on a moving speed of the vehicle C, a processing capacity of the electronic control apparatus 2, memory capacity, and the like.

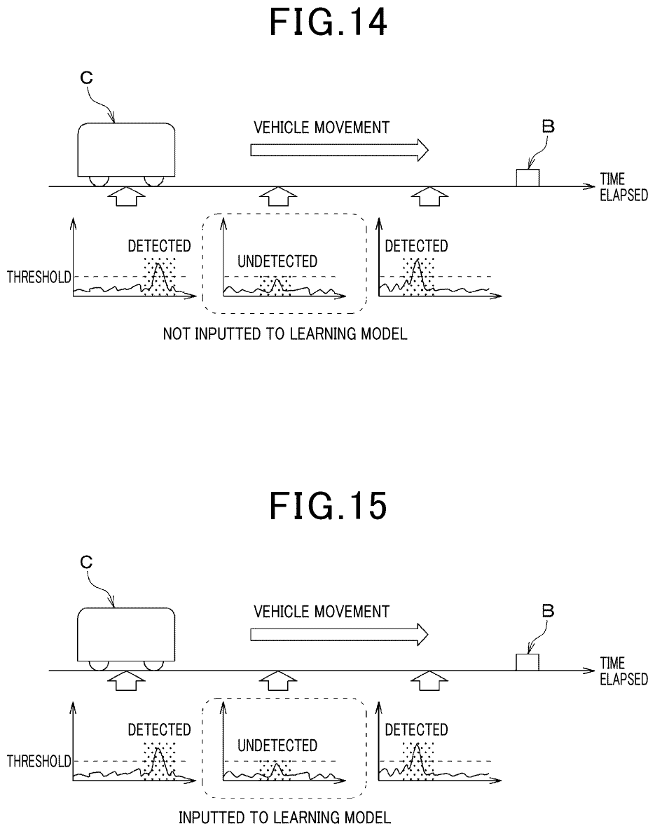

Specifically, as shown in FIG. 14, the determination unit 21 inputs, to the learning model, the feature quantity based on a signal in which a feature portion exceeding a predetermined amplitude value is present in the amplitude waveform, among the plurality of current feature quantities and the plurality of past feature quantities. Then, the determination unit 21 determines the shape of object B by calculating the feature quantity based on the signal in which the feature portion exceeding the predetermined amplitude value is present in the amplitude waveform, among the plurality of current feature quantities and the plurality of past feature quantities, while weighting with a predetermined weight. The electronic control apparatus 2 according to the present embodiment then outputs information indicating that the height of the object B is “tall” or “short” as the determination result for the shape of the object B. Here, the electronic control apparatus 2 may output information other than the information indicating that the height of the object B is “tall” or “short” as the determination result for the shape of the object B.

Other sections are similar to those according to the first embodiment. The onboard system 1 according to the present embodiment can acquire effects achieved by configurations shared with or equivalent to the first embodiment in a manner similar to that according to the first embodiment.

In addition, the onboard system 1 according to the present embodiment includes the following features.

(1) The determination unit 21 determines the shape of the object B by calculating the plurality of current feature quantities and at least a portion of the plurality of past feature quantities while weighting with a predetermined weight. The past feature quantity is based on the feature element having a correlation with the shape of the object B included in the reception signal acquired in the past, and in a manner similar to the current feature quantity, is information having a certain correlation with the shape of the object B. Therefore, if the configuration is such that the shape of the object B is determined by the plurality of current feature quantities and at least a portion of the plurality of past feature quantities being calculated while weighting with a predetermined weight, with at least a portion of the plurality of past feature quantities as the measurement information, the shape of the object B can be appropriately determined. In particular, if not only the current feature quantities but also the past feature quantities are inputted to the learning model as the measurement information, changes in the feature quantity based on changes in the amplitude and the phase of the reception signal are also inputted to the learning model. Therefore, the shape of the object B can be more appropriately determined.

(2) The determination unit 21 determines the shape of the object B by calculating not only the plurality of feature quantities but also the position change information indicating the changes in the position at which the reception signal is received, while weighting with a predetermined weight. In this way, if the configuration is such that the shape of the object B is determined by the plurality of feature quantities and the position change information being calculated while weighting with a predetermined weight, with the position change information as the measurement information in addition to the plurality of feature quantities, the shape of the object B can be appropriately determined.

(3) The determination unit 21 determines the shape of the object B by calculating the feature quantity based on the signal in which the feature portion exceeding the predetermined amplitude value is present in the amplitude waveform, among the plurality of current feature quantities and the plurality of past feature quantities, while weighting with a predetermined weight. In this way, if the configuration is such that the shape of the object B is determined from the feature quantity based on the signal in which the feature portion exceeding the predetermined amplitude value is present in the amplitude waveform of the reception signal, the data amount processed by the information processing unit 8 can be efficiently reduced. (Variation examples according to the fourth embodiment)

In cases in which the object B is in a position that affects the reception signal, the amplitude waveform of the reception signal typically becomes larger. However, for example, as shown in a middle section in FIG. 15, the amplitude waveform of the reception signal may become small as a result of fluctuations in air current, wave interference, and the like in a real environment. In cases in which the object B is in a position that affects the reception signal, it is highly probable that the amplitude waveform of the reception signal includes changes attributed to the object B even if the amplitude waveform of the reception signal is small.

Therefore, when the object B is estimated to be in a position that affects the reception signal, the determination unit 21 may determine the shape of the object B using not only the feature quantity that is based on the signal in which the feature portion is present, among the plurality of feature quantities, but also the feature quantity that is based on a signal in which the feature portion is not present. As a result of a configuration such as this, the shape of the object B can be appropriately determined.

Here, the estimation of whether the object B is in a position that affects the reception signal can be performed based on the amplitude waveform of the reception signal received previously and the position change information. For example, the determination unit 21 may be configured to estimate that the object B is in a position that affects the reception signal when the feature portion exceeding the predetermined amplitude value is present in the amplitude waveform of the reception received previously and the change in position of the ultrasonic sensor 3 from a previous position is equal to or less than a predetermined value.

In addition, as according to the above-described fourth embodiment, the determination unit 21 is preferably configured to determine the shape of the object B by calculating not only the plurality of feature quantities but also the measured distance and the position change information while weighting with a predetermined weight, but may not be configured as such.

### Fifth Embodiment

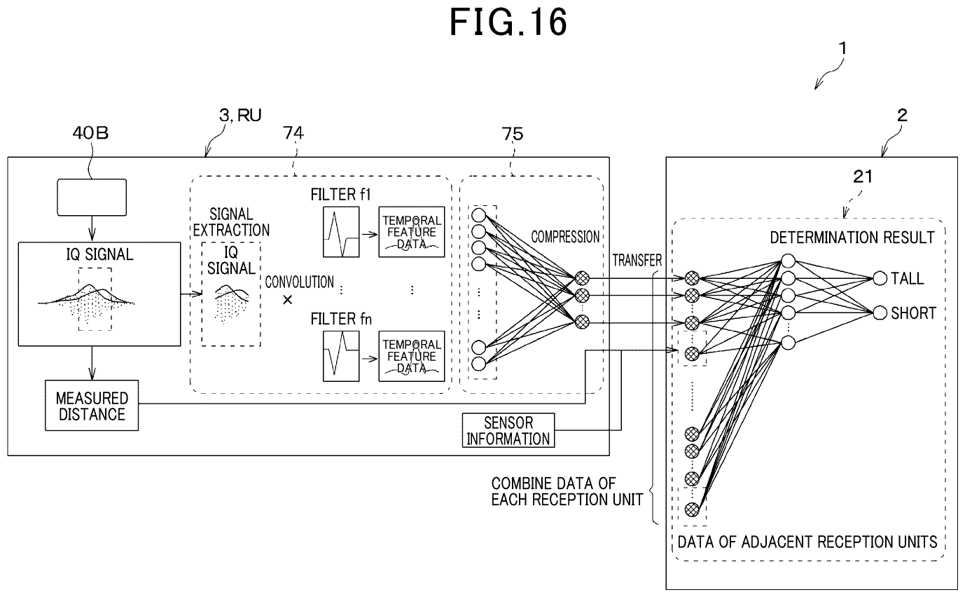

Next, a fifth embodiment will be described with reference to FIG. 16 to FIG. 18.

According to the present embodiment, sections differing from those according to the first embodiment will mainly be described.

The ultrasonic sensor 3 configures a reception unit RU that includes the reception unit 40B and the feature extraction unit 74. In the onboard system 1, a plurality of reception units RU are disposed in differing positions in the vehicle C. The reception units RU that are adjacent to each other may receive the reflected wave from the same object B. For example, as shown in FIG. 1, when the object B is in front of the vehicle C, both the first front sensor 3A and the second front sensor 3B may receive the reflected wave from the object B.

When a plurality of feature quantities obtained by compressing the temporal feature data based on the reception signal acquired by one reception unit RU of the adjacent reception units RU is a first feature quantity, the first feature quantity is based on a feature element having a correlation with the shape of the object B included in the reception signal. In addition, when a plurality of feature quantities obtained by compressing the temporal feature data based on the reception signal acquired by the other reception unit RU is a second feature quantity, the second feature quantity is based on a feature element having a correlation with the shape of the object B included in the reception signal. Therefore, the first feature quantity and the second feature quantity have a certain correlation with the shape of the object B.

Here, when a distance between the reception unit 40B and the transmission unit 40A that emits the transmission wave is small, intensity of the reception signal corresponding to the reflected wave from the object B tends to be large. In addition, as a distance between the plurality of reception units 40B becomes closer, a difference in the intensity of the reception signals corresponding to the reflected wave from the object B tends to become smaller. In this way, the positions of the plurality of reception units 40 B in relation to the transmission unit 40A and the positional relationship between the plurality of reception units 40B have a certain correlation with the changes in the waveform of the reception signal.

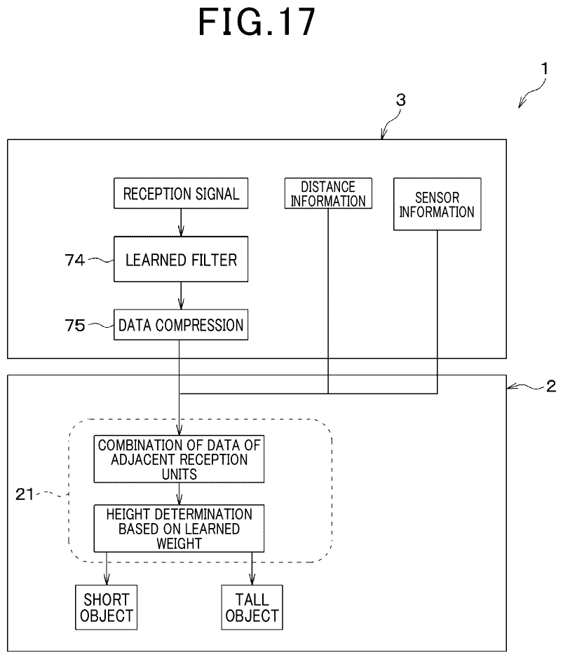

Taking the foregoing into consideration, as shown in FIG. 16 and FIG. 17, the onboard system 1 according to the present embodiment determines the shape of the object B using not only the first feature quantity included in the reception signal corresponding to the reflected wave from the object B, but also the second feature quantity and sensor information.

The ultrasonic sensor 3 according to the present embodiment is configured to be capable of outputting data associating a mounting position of the ultrasonic sensor 3 itself in the vehicle C and transmission/reception of the signals as the sensor information. Upon receiving a command signal from the electronic control apparatus 2, the plurality of ultrasonic sensors 3 emit the transmission waves that are ultrasonic waves in a predetermined sequence. In addition, the ultrasonic sensors 3 periodically receive the reception waves that include the reflected waves of the transmission waves from the object B. Then, the ultrasonic sensor 3 compresses the temporal feature data and acquires a plurality of feature quantities in the fully connected layer of the learning model. Subsequently, the ultrasonic sensor 3 transfers the data including the plurality of feature quantities, the measured distance, and the sensor information to the electronic control apparatus 2 over the bus-type network.

Upon receiving the data including the plurality of feature quantities and the like from the plurality of ultrasonic sensors 3, the electronic control apparatus 2 weights the data with pre-learned weight in the fully connected layer of the learning model and combines data such as the feature quantities transferred from adjacent reception units RU. The determination unit 21 determines the shape of the object B based on the data such as the feature quantities transferred from the adjacent reception units RU. Here, the measurement information expressed as the one-hot vector is inputted to the determination unit 21 of the electronic control apparatus 2.

Specifically, as shown in FIG. 18, the determination unit 21 inputs the feature quantity that is based on the signal in which the feature portion exceeding the predetermined amplitude value is present in the amplitude waveform, among the plurality of first feature quantities and the plurality of second feature quantities, to the learning model. In other words, the determination unit 21 does not input the feature quantity that is based on the signal in which the feature portion exceeding the predetermined amplitude value is not present in the amplitude waveform, among the plurality of first feature quantities and the plurality of second feature quantities, to the learning model. Then, the determination unit 21 determines the shape of object B by calculating the feature quantity that is based on the signal in which the feature portion exceeding the predetermined amplitude value is present in the amplitude waveform, among the plurality of first feature quantities and the plurality of second feature quantities, while weighting with a predetermined weight. The electronic control apparatus 2 according to the present embodiment outputs the information indicating that the height of the object B is “tall” or “short” as the determination result of the shape of the object B. Here, the electronic control apparatus 2 may output information other than the information indicating that the height of the object B is “tall” or “short” as the determination result of the shape of the object B.

Other sections are similar to those according to the first embodiment. The onboard system 1 according to the present embodiment can acquire effects achieved by configurations shared with or equivalent to the first embodiment in a manner similar to that according to the first embodiment.

In addition, the onboard system 1 according to the present embodiment includes the following features.

(1) The determination unit 21 determines the shape of object B by calculating at least a portion of the plurality of first feature quantities and the plurality of second feature quantities while weighting with predetermined weights. The first feature quantity and the second feature quantity are based on a feature element having a correlation with the shape of the object B included in the reception signal and is information having a certain correlation with the shape of the object B. Therefore, if the configuration is such that the shape of the object B is determined by at least a portion of the plurality of first feature quantities and second feature quantities being calculated while weighting with a predetermined weight, with at least a portion of the plurality of first feature quantities and second feature quantities as the measurement information, the shape of the object B can be appropriately determined.

(2) The determination unit 21 determines the shape of the object B by calculating not only the plurality of feature quantities but also the sensor information indicating the positions of the plurality of reception units 40B in relation to the transmission unit 40A that emits the transmission wave and the positional relationship between the plurality of reception units 40B, while weighting with a predetermined weight. In this way, if the configuration is such that the shape of the object B is determined by the plurality of feature qualities and the sensor information being calculated while weighting with a predetermined weight, with the sensor information as the measurement information in addition to the plurality of feature quantities, the shape of the object B can be appropriately determined.

(3) The determination unit 21 determines the shape of the object B by calculating the feature quantity that is based on the signal in which the feature portion exceeding the predetermined amplitude value is present in the amplitude waveform, among the plurality of first feature quantities and the plurality of second feature quantities, while weighting with a predetermined weight. In this way, if the configuration is such that the shape of the object B is determined from the feature quantity based on the signal in which the feature portion exceeding the predetermined amplitude value is present in the amplitude waveform of the reception signal, the data amount processed by the information processing unit 8 can be efficiently reduced.

### Variation Examples According to the Fifth Embodiment

In cases in which the amplitude waveform of the reception signal in one reception unit RU of the adjacent reception units RU is large, it is highly probable that the amplitude waveform of the reception signal includes changes attributed to the object B even if the amplitude waveform of the reception signal in the other adjacent reception unit RU is small.

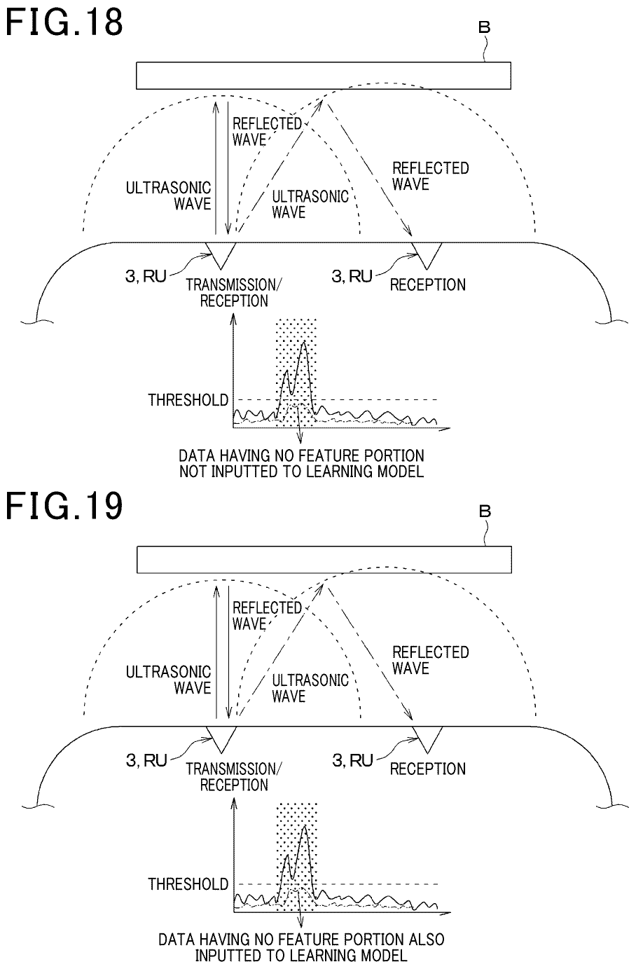

Therefore, as shown in FIG. 19, in cases in which the feature portion is present in the reception signal in one reception unit RU, the shape of the object B may be determined using the first feature quantity and the second feature quantity even if the feature portion is not present in the reception signal in the other reception unit RU. As a result of a configuration such as this, the shape of the object B can be appropriately determined.

In addition, as according to the above-described fifth embodiment, the determination unit 21 is preferably configured to determine the shape of the object B by calculating not only the plurality of feature quantities but also the measured distance and the sensor information while weighting with a predetermined weight, but may not be configured as such.

### Other Embodiments

Other sections are similar to those according to the first embodiment. The onboard system 1 according to the present embodiment can acquire effects achieved by configurations shared with or equivalent to the first embodiment in a manner similar to that according to the first embodiment.

In addition, the onboard system 1 according to the present embodiment includes the following features.

Although the representative embodiments of the present disclosure are described above, the present disclosure is not limited to the above-described embodiments and can be modified in various ways as follows.

As according to the above-described embodiments, the determination unit 21 preferably inputs the measured distance to the learning model as the measurement information. However, the determination unit 21 may not be configured as such. According to the above-described embodiments, the feature extraction unit 74 is configured to identify the feature element present in the portion of the amplitude waveform of the reception signal exceeding the predetermined threshold and extract the changes over time in the feature element as the temporal feature data. However, the feature extraction unit 74 may not be configured as such. For example, the feature extraction unit 74 may identify the feature element of the reception signal by collating the waveform of the reception signal with a waveform pattern prepared in advance.

As according to the above-described embodiments, the data compression unit 75 and the determination unit 21 are preferably provided in differing components. However, this is not limited thereto. The data compression unit 75 and the determination unit 21 may be provided in the same component. For example, the data compression unit 75 and the determination unit 21 may be provided in the electronic control apparatus 2. Here, the ultrasonic sensor 3 and the electronic control apparatus 2 may be connected by a star-type network, for example, rather than the bus-type network.

As according to the above-described embodiments, the determination unit 21 is preferably configured such that the measurement information expressed as the one-hot vector is inputted thereto. However, this is not limited thereto. The measurement information expressed in another format may be inputted.

The learning model of the information processing unit 8 is not limited to that described above and, for example, may be configured by a recurrent neural network (so-called RNN). In addition, the learning model may be configured by a model other than a neural network but is preferably configured as a nonlinear model.

According to the above-described embodiments, various types of information are given as the measurement information inputted to the learning model. However, this is not limited thereto. For example, the measurement information may include information related to the object B detected by an onboard camera, weather information, or time information.

According to the above-described embodiments, an example in which the object detection apparatus of the present disclosure is applied to the onboard system 1 is described.

However, the object detection apparatus can also be applied to a system other than the onboard system 1.

According to the above-described embodiments, it goes without saying that an element that configures the embodiment is not necessarily a requisite unless particularly specified as being a requisite, clearly considered a requisite in principle, or the like.

According to the above-described embodiments, in cases in which a numeric value, such as quantity, numeric value, amount, or range, of a constituent element is stated, the present invention is not limited to the specific number unless particularly specified as being a requisite, clearly limited to the specific number in principle, or the like.

According to the above-described embodiments, when a shape, a positional relationship, or the like of a constituent element or the like is mentioned, excluding cases in which the shape, the positional relationship, or the like is clearly described as particularly being a requisite, is clearly limited to a specific shape, positional relationship, or the like in principle, or the like, the present invention is not limited to the shape, positional relationship, or the like.

The control unit and the method thereof described in the present disclosure may be actualized by a dedicated computer that is provided such as to be configured by a processor and a memory, the processor being programmed to provide one or a plurality of functions that are realized by a computer program. The control unit and the method thereof described in the present disclosure may be actualized by a dedicated computer that is provided by a processor being configured by a single dedicated hardware logic circuit or more. The control unit and the method thereof described in the present disclosure may be actualized by a single dedicated computer or more. The dedicated computer may be configured by a combination of a processor that is programmed to provide one or a plurality of functions, a memory, and a processor that is configured by a single hardware logic circuit or more. The computer program may be stored in a non-transitory, tangible recording medium that can be read by a computer as instructions performed by the computer.

### Aspects of the Present Disclosure

Aspects below are disclosed in the present specification.

### First Aspect

An object detection apparatus that detects an object (B), the object detection apparatus including: a reception unit (40B) that acquires a reception signal corresponding to a reflected wave from the object of a transmission wave that is an ultrasonic wave; and an information processing unit (8) that acquires object information related to a shape of the object from a learning model by inputting a feature quantity and other measurement information of a waveform of the reception signal to the learned learning model in which machine learning to estimate the shape of an object has been performed, in which the learning model includes a feature extraction unit (74) that extracts, as temporal feature data, changes over time in a feature element included in the reception signal based on the reception signal and a feature pattern of the object prescribed in advance, a data compression unit (75) that compresses the temporal feature data and acquires a plurality of feature quantities, and a determination unit (21) that determines the shape of the object by calculating the plurality of feature quantities and the measurement information while weighting with a predetermined weight, and the measurement information is information having a correlation with changes in the waveform of the reception signal or the shape of the object.

### Second Aspect

The object detection apparatus according to the first aspect, further including: a distance acquisition unit (72) that acquires a distance to the object based on the reception signal, in which the measurement information includes the distance acquired by the distance acquisition unit.

### Third Aspect

The object detection apparatus according to the first or second aspect, in which: the measurement information includes at least one of a temperature, humidity, and windspeed in the vicinity of an apparatus in which the reception unit is mounted.

### Fourth Aspect

The object detection apparatus according to any one of the first to third aspects, in which: when the plurality of feature quantities obtained by compressing the temporal feature data currently extracted by the feature extraction unit is a plurality of current feature quantities and the plurality of feature quantities obtained by compressing the temporal feature data extracted in the past is a plurality of past feature quantities, the measurement information includes at least a portion of the plurality of past feature quantities, and the determination unit determines the shape of the object by calculating the plurality of current feature quantities and at least a portion of the plurality of past feature quantities while weighting with a predetermined weight.

### Fifth Aspect

The object detection apparatus according to the fourth aspect, in which: the measurement information includes position change information indicating changes in a position at which the reception signal is received.

### Sixth Aspect

The object detection apparatus according to the fourth or fifth aspect, in which: the determination unit determines the shape of the object by calculating a feature quantity based on a signal in which a feature portion exceeding a predetermined amplitude value is present in an amplitude waveform, among the plurality of current feature quantities and the plurality of past feature quantities, while weighting with a predetermined weight.

### Seventh Aspect

The object detection apparatus according to the fourth or fifth aspect, in which: the determination unit determines the shape of the object by calculating a feature quantity based on a signal in which a feature portion exceeding a predetermined amplitude value is present in an amplitude waveform and a feature quantity based on a signal in which the feature portion is not present, among the plurality of current feature quantities and the plurality of past feature quantities, while weighting with a predetermined weight, when the object is estimated to be in a position affecting the reception signal.

### Eighth Aspect

The object detection apparatus according to any one of the first to eleventh aspects, in which: a plurality of reception units including the reception unit and the feature extraction unit are disposed in differing positions; when the plurality of feature quantities obtained by compressing the temporal feature data based on the reception signal acquired by a portion of reception units among the plurality of reception units is the plurality of first feature quantities, and the plurality of feature quantities obtained by compressing the temporal feature data based on the reception signal acquired by another reception unit during a same time period as the acquisition of the reception signal by the portion of reception units is the plurality of second feature quantities, the measurement information includes at least a portion of the plurality of second feature quantities, and the determination unit determines the shape of the object by calculating the plurality of first feature quantities and at least a portion of the plurality of second feature quantities.

### Ninth Aspect

The object detection apparatus according to the eighth aspect, in which: the measurement information includes sensor information indicating positions of a plurality of reception units in relation to a transmission unit (40A) that emits the transmission wave, and a positional relationship between the plurality of reception units.

### Tenth Aspect

The object detection apparatus according to the eighth or ninth aspect, in which: the determination unit determines the shape of the object by calculating a feature quantity based on a signal in which a feature portion exceeding a predetermined amplitude value is present in an amplitude waveform, among the plurality of first feature quantities and the plurality of second feature quantities, while weighting with a predetermined weight.

### Eleventh Aspect

The object detection apparatus according to the eighth or ninth aspect, in which: the determination unit determines the shape of the object by calculating, when a feature portion exceeding a predetermined amplitude value is present in an amplitude waveform of the reception signal received by one reception unit of reception units that are adjacent to each other, the first feature quantity and the second feature quantity while weighting with a predetermined weight, even if the feature portion is not present in the amplitude waveform of the reception signal received by the other reception unit.

### Twelfth Aspect

The object detection apparatus according to any one of the first to eleventh aspects, in which: the feature extraction unit identifies a feature element present in a portion exceeding a predetermined threshold in an amplitude waveform of the reception signal and extracts, as the temporal feature data, changes over time in the feature element during a predetermined period including the feature element.

### Thirteenth Aspect

The object detection apparatus according to any one of the first to twelfth aspects, in which: the data compression unit and the determination unit are provided in differing components, and the plurality of feature quantities obtained by compression by the data compression unit are transferred to the determination unit over a communication network.

### Fourteenth Aspect

The object detection apparatus according to any one of the first to thirteenth aspects, in which: the measurement information expressed as a one-hot vector is inputted to the determination unit.

What is claimed is:

1. An object detection apparatus that detects an object, the object detection apparatus comprising:
a reception unit that acquires a reception signal corresponding to a reflected wave from the object of a transmission wave that is an ultrasonic wave; and
an information processing unit that acquires object information related to a shape of the object from a learning model by inputting a feature quantity and other measurement information of a waveform of the reception signal to the learned learning model in which machine learning to estimate the shape of an object has been performed, wherein
the learning model includes
a feature extraction unit that extracts, as temporal feature data, changes over time in a feature element included in the reception signal based on the reception signal and a feature pattern of the object prescribed in advance,
a data compression unit that compresses the temporal feature data and acquires a plurality of feature quantities, and
a determination unit that determines the shape of the object by calculating the plurality of feature quantities and the measurement information while weighting with a predetermined weight, and
the measurement information is information having a correlation with changes in the waveform of the reception signal or the shape of the object.

2. The object detection apparatus according to claim 1, further comprising:
a distance acquisition unit that acquires a distance to the object based on the reception signal, wherein
the measurement information includes the distance acquired by the distance acquisition unit.

3. The object detection apparatus according to claim 1, wherein:
the measurement information includes at least one of a temperature, humidity, and windspeed in the vicinity of an apparatus in which the reception unit is mounted.

4. The object detection apparatus according to claim 1, wherein:
when the plurality of feature quantities obtained by compressing the temporal feature data currently extracted by the feature extraction unit is a plurality of current feature quantities and the plurality of feature quantities obtained by compressing the temporal feature data extracted in the past is a plurality of past feature quantities,
the measurement information includes at least a portion of the plurality of past feature quantities, and
the determination unit determines the shape of the object by calculating the plurality of current feature quantities and at least a portion of the plurality of past feature quantities while weighting with a predetermined weight.

5. The object detection apparatus according to claim 4, wherein:
the measurement information includes position change information indicating changes in a position at which the reception signal is received.

6. The object detection apparatus according to claim 4, wherein:
the determination unit determines the shape of the object by calculating a feature quantity based on a signal in which a feature portion exceeding a predetermined amplitude value is present in an amplitude waveform, among the plurality of current feature quantities and the plurality of past feature quantities, while weighting with a predetermined weight.

7. The object detection apparatus according to claim 4, wherein:
the determination unit determines the shape of the object by calculating a feature quantity based on a signal in which a feature portion exceeding a predetermined amplitude value is present in an amplitude waveform and a feature quantity based on a signal in which the feature portion is not present, among the plurality of current feature quantities and the plurality of past feature quantities, while weighting with a predetermined weight, when the object is estimated to be in a position affecting the reception signal.

8. The object detection apparatus according to claim 1, wherein:
a plurality of reception units including the reception unit and the feature extraction unit are disposed in differing positions;
when the plurality of feature quantities obtained by compressing the temporal feature data based on the reception signal acquired by a portion of reception units among the plurality of reception units is the plurality of first feature quantities, and the plurality of feature quantities obtained by compressing the temporal feature data based on the reception signal acquired by another reception unit during a same time period as the acquisition of the reception signal by the portion of reception units is the plurality of second feature quantities,
the measurement information includes at least a portion of the plurality of second feature quantities, and
the determination unit determines the shape of the object by calculating the plurality of first feature quantities and at least a portion of the plurality of second feature quantities.

9. The object detection apparatus according to claim 8, wherein:
the measurement information includes sensor information indicating positions of a plurality of reception units in relation to a transmission unit (40A) that emits the transmission wave, and a positional relationship between the plurality of reception units.

10. The object detection apparatus according to claim 8, wherein:
the determination unit determines the shape of the object by calculating a feature quantity based on a signal in which a feature portion exceeding a predetermined amplitude value is present in an amplitude waveform, among the plurality of first feature quantities and the plurality of second feature quantities, while weighting with a predetermined weight.

11. The object detection apparatus according to claim 8, wherein:
the determination unit determines the shape of the object by calculating, when a feature portion exceeding a predetermined amplitude value is present in an amplitude waveform of the reception signal received by one reception unit of reception units that are adjacent to each other, the first feature quantity and the second feature quantity while weighting with a predetermined weight, even if the feature portion is not present in the amplitude waveform of the reception signal received by the other reception unit.

12. The object detection apparatus according to claim 1, wherein:
the feature extraction unit identifies a feature element present in a portion exceeding a predetermined threshold in an amplitude waveform of the reception signal and extracts, as the temporal feature data, changes over time in the feature element during a predetermined period including the feature element.

13. The object detection apparatus according to claim 1, wherein:
the data compression unit and the determination unit are provided in differing components, and the plurality of feature quantities obtained by compression by the data compression unit are transferred to the determination unit over a communication network.

14. The object detection apparatus according to claim 1, wherein:
the measurement information expressed as a one-hot vector is inputted to the determination unit.
